(19) United States
(12) Patent Application Publication
(10) Pub. No.: US 2013/0174201 A1
(43) Pub. Date: Jul. 4, 2013

(54) SYSTEMS AND METHODS FOR PRESENTING THREE-DIMENSIONAL OBJECTS IN AN INTERACTIVE MEDIA GUIDANCE APPLICATION

(71) Applicant: Terry Tam, Kowloon (HK)

(72) Inventor: Terry Tam, Kowloon (HK)

(73) Assignee: UNITED VIDEO PROPERTIES, INC., Santa Clara, CA (US)

(21) Appl. No.: 13/341,155

(22) Filed: Dec. 30, 2011

(51) Int. Cl. H04N 21/482

(52) U.S. Cl. 725/40

(57) ABSTRACT

Systems and methods for presenting an interactive media guidance application are provided. One or more three-dimensional objects are presented in a guidance display, where each three-dimensional object represents a media asset. In response to receiving an indication from the user of one of the three-dimensional objects, the selected three-dimensional object or a region containing the selected three-dimensional object may be animated. The animation of the selected three-dimensional object or the region containing the selected three-dimensional object in the guidance display may be made relative to the remainder of three-dimensional objects that have not been selected by the user.

### BACKGROUND OF THE INVENTION

Due to the overwhelming volume of media content (e.g., television shows) available to the average person (e.g., via cable or satellite television), interactive media guidance applications, such as interactive program guides, have gained widespread popularity. Typically, these guidance applications present guide listings in a two-dimensional grid indexed by time and source (e.g., a television channel). In addition to listings, guidance applications provide information in the cells of the two-dimensional grid, such as content listings, channel identifiers, and time periods, along with various options for browsing through the listings. A selected cell within the grid or a selected option is usually highlighted by, for example, underlining content that appears within the selected cell or option, changing the background color of the selected cell or option, or outlining one or more borders of the selected cell or option. These approaches, however, are flat and uninteresting and may not grasp the viewer's attention.

### SUMMARY OF THE INVENTION

In view of the foregoing, systems and methods for presenting an interactive media guidance application are provided. In particular, the interactive media guidance application presents a user with three-dimensional objects in a guidance display, where each three-dimensional object represents a media asset (e.g., a television channel or a content source). In response to receiving a user request to access a guidance display, a subset of three-dimensional objects may be selected and presented on the guidance display. In response to receiving an indication from the user of one of the three-dimensional objects, the interactive media guidance application may provide one or more animations that modify the selected three-dimensional object or a region containing the selected three-dimensional object. The modifications to the selected three-dimensional object or the region containing the selected three-dimensional object may be made relative to the remainder of three-dimensional objects that have not been selected by the user.

In some embodiments, a user request to access a guidance display is received. In particular, a user may select a listings icon from a program listings display to instruct control circuitry to receive program listings and associated content information. The control circuitry may, in response to receiving the user request, present a guidance display that includes a subset of three-dimensional objects, where each three-dimensional object represents a media asset. The media asset may be, for example, a channel (e.g., FOX), a content type identifier (e.g., CNN.com), an identifier for a third-party application (e.g., a YouTube application), or a listing for a television program. In addition, the three-dimensional object may be in the form of a cube, a sphere, a rectangular prism, a triangular prism, a cylinder, a pyramid, or any other suitable shape.

In response to receiving a user selection of one of the three-dimensional objects, the control circuitry may animate the selected three-dimensional object or a region containing the selected three-dimensional object. The animation may modify the selected three-dimensional object or a region containing the selected three-dimensional object relative to the subset of three-dimensional objects that have not been selected by the user. For example, the animation may cause the selected three-dimensional object to perform a particular motion, such as a floating motion, a flipping motion, a bouncing motion, a vibrating motion, a rotating motion, a sliding motion, and/or any combination thereof. Upon providing the animation, the remaining three-dimensional objects that were not selected by the user may remain still.

It should be noted that, in some embodiments, the animation of the three-dimensional object may include modifying one or more properties of the selected three-dimensional object or one or more properties of the region containing the selected three-dimensional object. For example, the shape of the selected three-dimensional object may change back and forth between the original shape and another shape. In another example, the region containing the selected three-dimensional object may cycle through a number of background colors.

Alternatively, in some embodiments, the control circuitry may animate the three-dimensional objects that were not selected by the user. For example, the control circuitry may animate the unselected objects in such a manner that hides, minimizes, or de-emphasizes them from the selected three-dimensional object (e.g., an animation that causes the unselected objects to fade back).

### BRIEF DESCRIPTION OF THE DRAWINGS

The above and other objects and advantages of the invention will be apparent upon consideration of the following detailed description, taken in conjunction with the accompanying drawings, in which like reference characters refer to like parts throughout, and in which:

FIGS. 1 and 2 show illustrative display screens that may be used to provide media guidance application listings in accordance with some embodiments of the invention;

FIG. 3 shows an illustrative user equipment device in accordance with some embodiments of the invention;

FIG. 4 is a diagram of an illustrative cross-platform interactive media system in accordance with some embodiments of the invention;

FIGS. 5 and 6 show illustrative guidance display screens that include three-dimensional objects representing channel identifiers in accordance with some embodiments of the invention;

FIG. 7 shows another illustrative guidance display screen that includes columns of three-dimensional objects representing channel identifiers in accordance with some embodiments of the invention;

FIGS. 8 and 9 illustrate animated features that may be included in a region containing a three-dimensional object in accordance with some embodiments of the invention;

FIGS. 10 and 11 show illustrative guidance display screens that include options for configuring guidance displays in accordance with some embodiments of the invention;

FIG. 12 illustrates a display feature that may be used with three-dimensional objects in accordance with some embodiments of the invention;

FIG. 13 illustrates a flow diagram for presenting and animating three-dimensional objects in a guidance display in accordance with some embodiments of the invention; and

FIG. 14 shows an illustrative example of a file in Extensible Markup Language (XML) for retrieving three-dimensional objects and other content data used to generate guidance displays in accordance with some embodiments of the invention.

### DETAILED DESCRIPTION OF EMBODIMENTS

This invention generally relates to systems and methods for presenting three-dimensional objects in an interactive media guidance application. In particular, systems and methods are provided for animating three-dimensional objects that represent media assets in guidance displays.

The amount of content available to users in any given content delivery system can be substantial. Consequently, many users desire a form of media guidance through an interface that allows users to efficiently navigate content selections and easily identify content that they may desire. An application that provides such guidance is referred to herein as an interactive media guidance application or, sometimes, a media guidance application or a guidance application.

Interactive media guidance applications may take various forms depending on the content for which they provide guidance. One typical type of media guidance application is an interactive television program guide. Interactive television program guides (sometimes referred to as electronic program guides) are well-known guidance applications that, among other things, allow users to navigate among and locate many types of content. As referred to herein, the term “content” should be understood to mean an electronically consumable user asset, such as television programming, as well as pay-per-view programs, on-demand programs (as in video-on-demand (VOD) systems), Internet content (e.g., streaming content, downloadable content, Webcasts, etc.), video clips, audio, content information, pictures, rotating images, documents, playlists, websites, articles, books, electronic books, blogs, advertisements, chat sessions, social media, applications, games, and/or any other media or multimedia and/or combination of the same. Guidance applications also allow users to navigate among and locate content. As referred to herein, the term “multimedia” should be understood to mean content that utilizes at least two different content forms described above, for example, text, audio, images, video, or interactivity content forms. Content may be recorded, played, displayed or accessed by user equipment devices, but can also be part of a live performance.

With the advent of the Internet, mobile computing, and high-speed wireless networks, users are accessing media on user equipment devices on which they traditionally did not. As referred to herein, the phrase “user equipment device,” “user equipment,” “user device,” “electronic device,” “electronic equipment,” “media equipment device,” or “media device” should be understood to mean any device for accessing the content described above, such as a television, a Smart TV, a set-top box, an integrated receiver decoder (IRD) for handling satellite television, a digital storage device, a digital media receiver (DMR), a digital media adapter (DMA), a streaming media device, a DVD player, a DVD recorder, a connected DVD, a local media server, a BLU-RAY player, a BLU-RAY recorder, a personal computer (PC), a laptop computer, a tablet computer, a WebTV box, a personal computer television (PC/TV), a PC media server, a PC media center, a hand-held computer, a stationary telephone, a personal digital assistant (PDA), a mobile telephone, a portable video player, a portable music player, a portable gaming machine, a smart phone, or any other television equipment, computing equipment, or wireless device, and/or combination of the same. In some embodiments, the user equipment device may have a front facing screen and a rear facing screen, multiple front screens, or multiple angled screens. In some embodiments, the user equipment device may have a front facing camera and/or a rear facing camera. On these user equipment devices, users may be able to navigate among and locate the same content available through a television. Consequently, media guidance may be available on these devices, as well. The guidance provided may be for content available only through a television, for content available only through one or more of other types of user equipment devices, or for content available both through a television and one or more of the other types of user equipment devices. The media guidance applications may be provided as on-line applications (i.e., provided on a web-site), or as stand-alone applications or clients on user equipment devices. Various devices and platforms that may implement media guidance applications are described in more detail below.

One of the functions of the media guidance application is to provide media guidance data to users. As referred to herein, the phrase, “media guidance data” or “guidance data” should be understood to mean any data related to content, such as media listings, media-related information (e.g., broadcast times, broadcast channels, titles, descriptions, ratings information (e.g., parental control ratings, critic's ratings, etc.), genre or category information, actor information, logo data for broadcasters' or providers' logos, etc.), media format (e.g., standard definition, high definition, 3D, etc.), advertisement information (e.g., text, images, media clips, etc.), on-demand information, blogs, websites, and any other type of guidance data that is helpful for a user to navigate among and locate desired content selections.

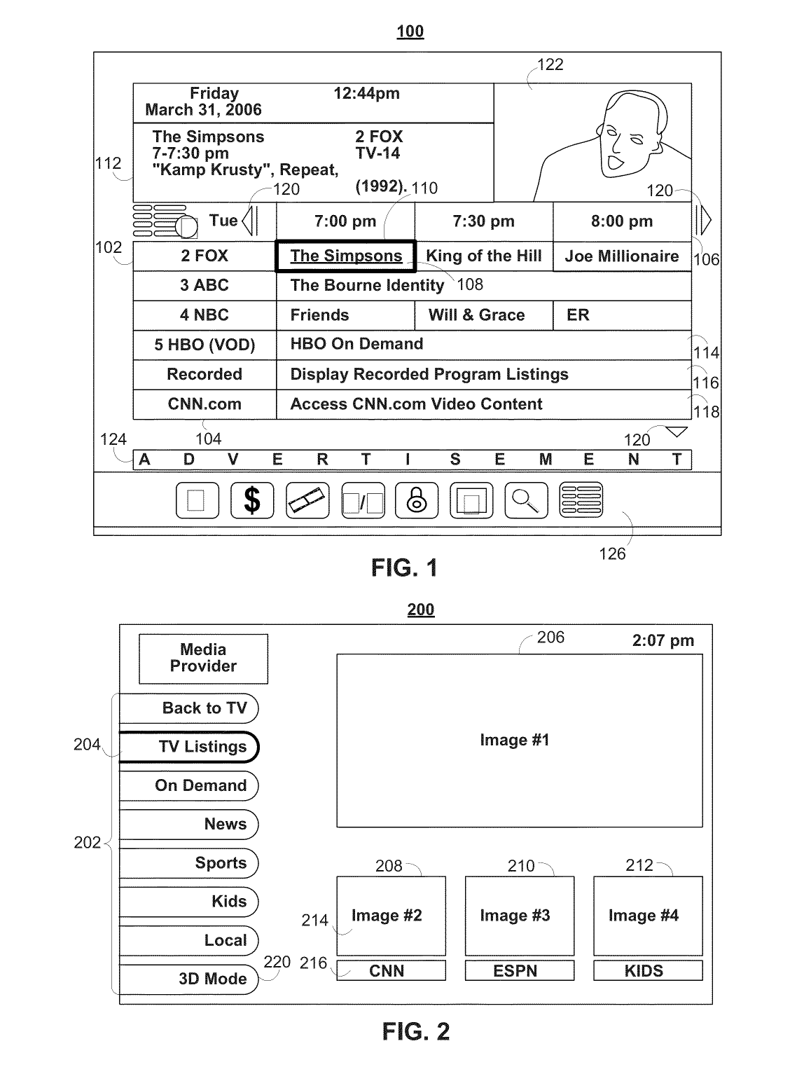

FIGS. 1, 2, 5-7, 10, and 11 show illustrative display screens that may be used to provide media guidance data. The display screens shown in FIGS. 1, 2, 5-7, 10, and 11 may be implemented on any suitable user equipment device or platform. While the displays of FIGS. 1, 2, 5-7, 10, and 11 are illustrated as full screen displays, they may also be fully or partially overlaid over content being displayed. A user may indicate a desire to access content information by selecting a selectable option provided in a display screen (e.g., a menu option, a listings option, an icon, a hyperlink, etc.) or pressing a dedicated button (e.g., a GUIDE button) on a remote control or other user input interface or device. In response to the user's indication, the media guidance application may provide a display screen with media guidance data organized in one of several ways, such as by time and channel in a grid, by time, by channel, by source, by content type, by category (e.g., movies, sports, news, children, or other categories of programming), or other predefined, user-defined, or other organization criteria. The organization of the media guidance data is determined by guidance application data. As referred to herein, the phrase, “guidance application data” should be understood to mean data used in operating the guidance application, such as program information, guidance application settings, user preferences, or user profile information.

FIG. 1 shows illustrative grid program listings display 100 arranged by time and channel that also enables access to different types of content in a single display. Display 100 may include grid 102 with: (1) a column of channel/content type identifiers 104, where each channel/content type identifier (which is a cell in the column) identifies a different channel or content type available; and (2) a row of time identifiers 106, where each time identifier (which is a cell in the row) identifies a time block of programming. Grid 102 also includes cells of program listings, such as program listing 108, where each listing provides the title of the program provided on the listing's associated channel and time. With a user input device, a user can select program listings by moving highlight region 110. Information relating to the program listing selected by highlight region 110 may be provided in program information region 112. Region 112 may include, for example, the program title, the program description, the time the program is provided (if applicable), the channel the program is on (if applicable), the program's rating, and other desired information.

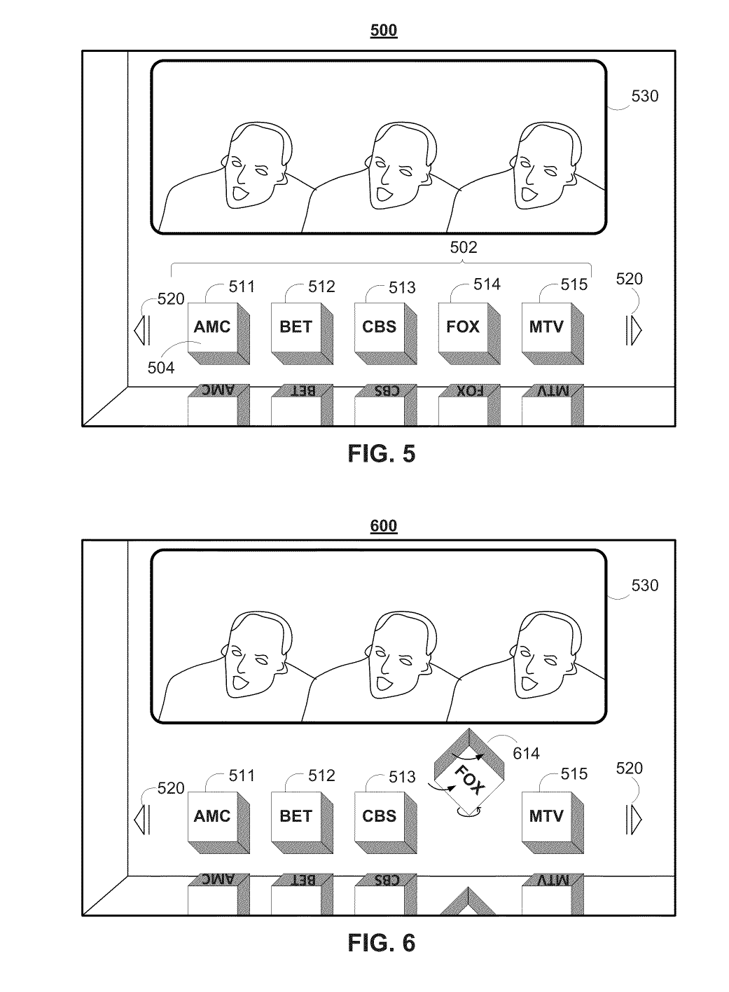

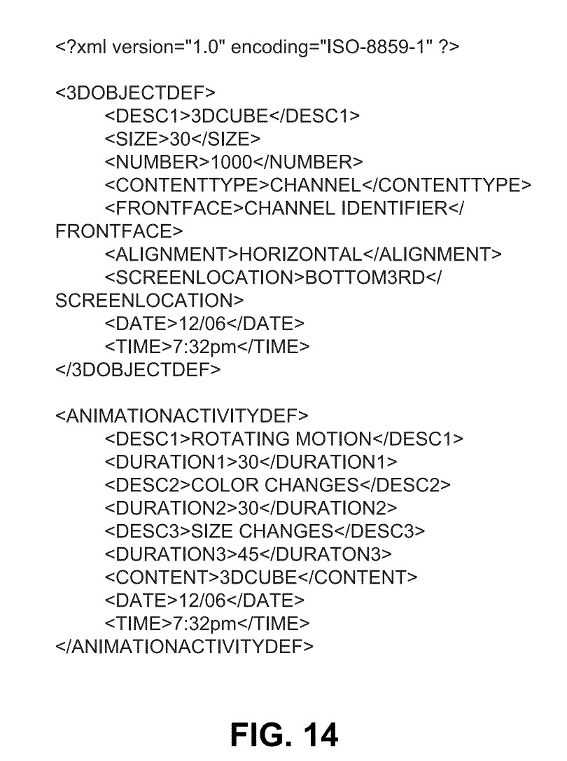

In some embodiments, one or more of channel/content type identifiers 104, time identifiers 106, and/or the program listing cells of grid 102 may be represented in display 100 by a three-dimensional object, such as a rectangular prism. For example, a face of the three-dimensional object may display the channel/content source, time period, program title, etc. In response to determining that a user has navigated to a three-dimensional object, the three-dimensional object may be animated relative to the other three-dimensional objects that were not selected by the user, as described more fully below in connection with FIGS. 5-14.

In addition to providing access to linear programming (e.g., content that is scheduled to be transmitted to a plurality of user equipment devices at a predetermined time and is provided according to a schedule), the media guidance application also provides access to non-linear programming (e.g., content accessible to a user equipment device at any time and is not provided according to a schedule). Non-linear programming may include content from different content sources including on-demand content (e.g., VOD), Internet content (e.g., streaming media, downloadable media, etc.), locally stored content (e.g., content stored on any user equipment device described above or other storage device), or other time-independent content. On-demand content may include movies or any other content provided by a particular content provider (e.g., HBO On Demand providing “The Sopranos” and “Curb Your Enthusiasm”). HBO ON DEMAND is a service mark owned by Time Warner Company L. P. et al. and THE SOPRANOS and CURB YOUR ENTHUSIASM are trademarks owned by the Home Box Office, Inc. Internet content may include web events, such as a chat session or Webcast, or content available on-demand as streaming content or downloadable content through an Internet web site or other Internet access (e.g. FTP).

Grid 102 may provide media guidance data for non-linear programming including on-demand listing 114, recorded content listing 116, and Internet content listing 118. A display combining media guidance data for content from different types of content sources is sometimes referred to as a “mixed-media” display. Various permutations of the types of media guidance data that may be displayed that are different than display 100 may be based on user selection or guidance application definition (e.g., a display of only recorded and broadcast listings, only on-demand and broadcast listings, etc.). As illustrated, listings 114, 116, and 118 are shown as spanning the entire time block displayed in grid 102 to indicate that selection of these listings may provide access to a display dedicated to on-demand listings, recorded listings, or Internet listings, respectively. In some embodiments, listings for these content types may be included directly in grid 102. Additional media guidance data may be displayed in response to the user selecting one of the navigational icons 120. (Pressing an arrow key on a user input device may affect the display in a similar manner as selecting navigational icons 120.)

Display 100 may also include video region 122, advertisement 124, and options region 126. Video region 122 may allow the user to view and/or preview programs that are currently available, will be available, or were available to the user. The content of video region 122 may correspond to, or be independent from, one of the listings displayed in grid 102. Grid displays including a video region are sometimes referred to as picture-in-guide (PIG) displays. PIG displays and their functionalities are described in greater detail in Satterfield et al. U.S. Pat. No. 6,564,378, issued May 13, 2003 and Yuen et al. U.S. Pat. No. 6,239,794, issued May 29, 2001, which are hereby incorporated by reference herein in their entireties. PIG displays may be included in other media guidance application display screens of the embodiments described herein.

Advertisement 124 may provide an advertisement for content that, depending on a viewer's access rights (e.g., for subscription programming), is currently available for viewing, will be available for viewing in the future, or may never become available for viewing, and may correspond to or be unrelated to one or more of the content listings in grid 102. Advertisement 124 may also be for products or services related or unrelated to the content displayed in grid 102. Advertisement 124 may be selectable and provide further information about content, provide information about a product or a service, enable purchasing of content, a product, or a service, provide content relating to the advertisement, etc. Advertisement 124 may be targeted based on a user's profile/preferences, monitored user activity, the type of display provided, or on other suitable targeted advertisement bases.

While advertisement 124 is shown as rectangular or banner shaped, advertisements may be provided in any suitable size, shape, and location in a guidance application display. For example, advertisement 124 may be provided as a rectangular shape that is horizontally adjacent to grid 102. This is sometimes referred to as a panel advertisement. In addition, advertisements may be overlaid over content or a guidance application display or embedded within a display. Advertisements may also include text, images, rotating images, video clips, or other types of content described above. Advertisements may be stored in a user equipment device having a guidance application, in a database connected to the user equipment, in a remote location (including streaming media servers), or on other storage means, or a combination of these locations. Providing advertisements in a media guidance application is discussed in greater detail in, for example, Knudson et al., U.S. Patent Application Publication No. 2003/0110499, filed Jan. 17, 2003; Ward, III et al. U.S. Pat. No. 6,756,997, issued Jun. 29, 2004; and Schein et al. U.S. Pat. No. 6,388,714, issued May 14, 2002, which are hereby incorporated by reference herein in their entireties. It will be appreciated that advertisements may be included in other media guidance application display screens of the embodiments described herein.

Options region 126 may allow the user to access different types of content, media guidance application displays, and/or media guidance application features. Options region 126 may be part of display 100 (and other display screens described herein), or may be invoked by a user by selecting an on-screen option or pressing a dedicated or assignable button on a user input device. The selectable options within options region 126 may concern features related to program listings in grid 102 or may include options available from a main menu display. Features related to program listings may include searching for other air times or ways of receiving a program, recording a program, enabling series recording of a program, setting program and/or channel as a favorite, purchasing a program, or other features. Options available from a main menu display may include search options, VOD options, parental control options, Internet options, cloud-based options, device synchronization options, second screen device options, options to access various types of media guidance data displays, options to subscribe to a premium service, options to edit a user's profile, options to access a browse overlay, or other options.

In some embodiments, the user may navigate through media guidance application listings, such as the program listings shown in FIG. 1. The user may request that the media guidance application provide enhanced guidance displays by positioning highlight region 110 over a three-dimensional mode option and pressing a suitable key on a remote control (e.g., a select key). Alternatively, when the media guidance application is executed on user equipment, such as a wireless communications device, the media guidance application may determine whether the processing capabilities of the user equipment are suitable for providing enhanced guidance displays in the three-dimensional mode. In response to determining that the user equipment has sufficient processing capabilities, the media guidance application may activate the three-dimensional mode option.

In some embodiments, the media guidance application may activate the three-dimensional mode option in response to determining that three-dimensional objects are associated with the currently presented display screen. For example, the media guidance application may determine that three-dimensional objects are associated with a program listings display screen. In response to receiving a request to access the program listings display screen, the media guidance application may activate the three-dimensional mode option.

In some embodiments, the media guidance application may provide the user with one or more guidance displays that include three-dimensional objects, where each three-dimensional object represents a media asset. For example, as shown in FIGS. 5-12, the media guidance application may provide three-dimensional objects that represent a channel or a content source (e.g., FOX). However, it should be noted that any suitable portion of program listings display 100 or other displays described herein may be rendered as a three-dimensional object. For example, program listings 108 may be displayed as three-dimensional objects. In another example, the selectable options within options region 126 may be displayed as three-dimensional objects, where each three-dimensional object represents a selectable option and user selection of one of the three-dimensional objects causes that object to appear animated relative to the non-selected three-dimensional objects. In yet another example, one or more of navigational icons 120 may be displayed as three-dimensional objects, where each three-dimensional object represents a navigational icon.

Alternatively, in some embodiments, the media guidance application may provide a three-dimensional guidance display, where media assets that were previously rendered as two-dimensional objects are rendered as three-dimensional objects. For example, the user equipment may include a three-dimensional display and a video card or graphics card that may be instructed to generate a three-dimensional scene with the three-dimensional objects to output to the display.

It should be noted that the three-dimensional object may be in the form of a cube, a sphere, a rectangular prism, a triangular prism, a cylinder, a pyramid, or any other suitable shape.

It should also be noted that, in some embodiments, the animation of the three-dimensional object may include modifying one or more properties of the selected three-dimensional object or one or more properties of the region containing the selected three-dimensional object. For example, the shape of the selected three-dimensional object may change back and forth between the original shape and another shape. In another example, the region containing the selected three-dimensional object may cycle through a number of background colors.

In response to receiving a user selection of one of the three-dimensional objects, the media guidance application may animate the selected three-dimensional object or a region containing the selected three-dimensional object. The animation may modify the selected three-dimensional object relative to the subset of three-dimensional objects not selected by the user. For example, the animation may cause the selected three-dimensional object to perform a particular motion, such as a floating motion, a flipping motion, a bouncing motion, a vibrating motion, a rotating motion, a sliding motion, and/or any combination thereof. Upon providing the animation, the remaining three-dimensional objects that were not selected by the user may remain still.

In some embodiments, the animation of a three-dimensional object may add additional features to the replaced two-dimensional element. For example, in response to navigating to or selecting the three-dimensional object, the animation may include an audio clip that is played back to the user through speakers 314.

While providing the animation of the three-dimensional object, the media guidance application may perform an action relating to the media asset represented by the three-dimensional object. For example, when the three-dimensional object represents a channel, the media guidance application may tune to the channel, provide a preview of content being currently displayed on the channel, allow the user to schedule a reminder for viewing content on the channel, allow the user to schedule a recording for viewing content on the channel, provide a listing of content associated with the channel, etc.

The media guidance application may be personalized based on a user's preferences. A personalized media guidance application allows a user to customize displays and features to create a personalized “experience” with the media guidance application. This personalized experience may be created by allowing a user to input these customizations and/or by the media guidance application monitoring user activity to determine various user preferences. Users may access their personalized guidance application by logging in or otherwise identifying themselves to the guidance application. Customization of the media guidance application may be made in accordance with a user profile. The customizations may include varying presentation schemes (e.g., color scheme of displays, font size of text, etc.), aspects of content listings displayed (e.g., only HDTV or only 3D programming, user-specified broadcast channels based on favorite channel selections, re-ordering the display of channels, recommended content, etc.), desired recording features (e.g., recording or series recordings for particular users, recording quality, etc.), parental control settings, customized presentation of Internet content (e.g., presentation of social media content, e-mail, electronically delivered articles, etc.) and other desired customizations.

For example, in some embodiments, the media guidance application may select one or more three-dimensional objects for presentation to the user based on a user profile, user preferences, etc. In a more particular example, customization of the media guidance application may be made in accordance with a user profile, where the user has indicated within the user profile that channel identifiers are to be presented as three-dimensional objects. In another example, the media guidance application may receive an indication from the user to replace two-dimensional objects with the three-dimensional objects, if available.

The media guidance application may allow a user to provide user profile information or may automatically compile user profile information. The media guidance application may, for example, monitor the content the user accesses and/or other interactions the user may have with the guidance application.

Additionally, the media guidance application may obtain all or part of other user profiles that are related to a particular user (e.g., from other web sites on the Internet the user accesses, such as www.allrovi.com, from other media guidance applications the user accesses, from other interactive applications the user accesses, from another user equipment device of the user, etc.), and/or obtain information about the user from other sources that the media guidance application may access. As a result, a user can be provided with a unified guidance application experience across the user's different user equipment devices. This type of user experience is described in greater detail below in connection with FIG. 4. Additional personalized media guidance application features are described in greater detail in Ellis et al., U.S. Patent Application Publication No. 2005/0251827, filed Jul. 11, 2005, Boyer et al., U.S. Pat. No. 7,165,098, issued Jan. 16, 2007, and Ellis et al., U.S. Patent Application Publication No. 2002/0174430, filed Feb. 21, 2002, which are hereby incorporated by reference herein in their entireties.

Another display arrangement for providing media guidance is shown in FIG. 2. Video mosaic display 200 includes selectable options 202 for content information organized based on content type, genre, and/or other organization criteria. In display 200, television listings option 204 is selected, thus providing listings 206, 208, 210, and 212 as broadcast program listings. In display 200 the listings may provide graphical images including cover art, still images from the content, video clip previews, live video from the content, or other types of content that indicate to a user the content being described by the media guidance data in the listing. Each of the graphical listings may also be accompanied by text to provide further information about the content associated with the listing. For example, listing 208 may include more than one portion, including media portion 214 and text portion 216. Media portion 214 and/or text portion 216 may be selectable to view content in full-screen or to view information related to the content displayed in media portion 214 (e.g., to view listings for the channel that the video is displayed on).

As described above, any suitable portion of program listings display 100, video mosaic display 200, or other displays described herein may be rendered as a three-dimensional object. For example, each text portion 216 of listing 208 may be displayed as a three-dimensional object with text displayed on a face of the three-dimensional object. In addition, when a three-dimensional object is selected by a user, the three-dimensional object may be animated relative to the non-selected objects.

A three-dimensional mode option 220 may be included to instruct the media guidance application to replace display features with three-dimensional objects that represent media assets. In particular, receiving a selection of three-dimensional mode option 220 may navigate the user to one of the guidance displays shown in FIGS. 5-7 and 10-11. Alternatively, the selection of three-dimensional mode option 220 may cause the guidance display to re-render itself with three-dimensional objects retrieved from a storage device.

The listings in display 200 are of different sizes (i.e., listing 206 is larger than listings 208, 210, and 212), but if desired, all the listings may be the same size. Listings may be of different sizes or graphically accentuated to indicate degrees of interest to the user or to emphasize certain content, as desired by the content provider or based on user preferences. Various systems and methods for graphically accentuating content listings are discussed in, for example, Yates, U.S. Patent Application Publication No. 2010/0153885, filed Dec. 29, 2005, which is hereby incorporated by reference herein in its entirety.

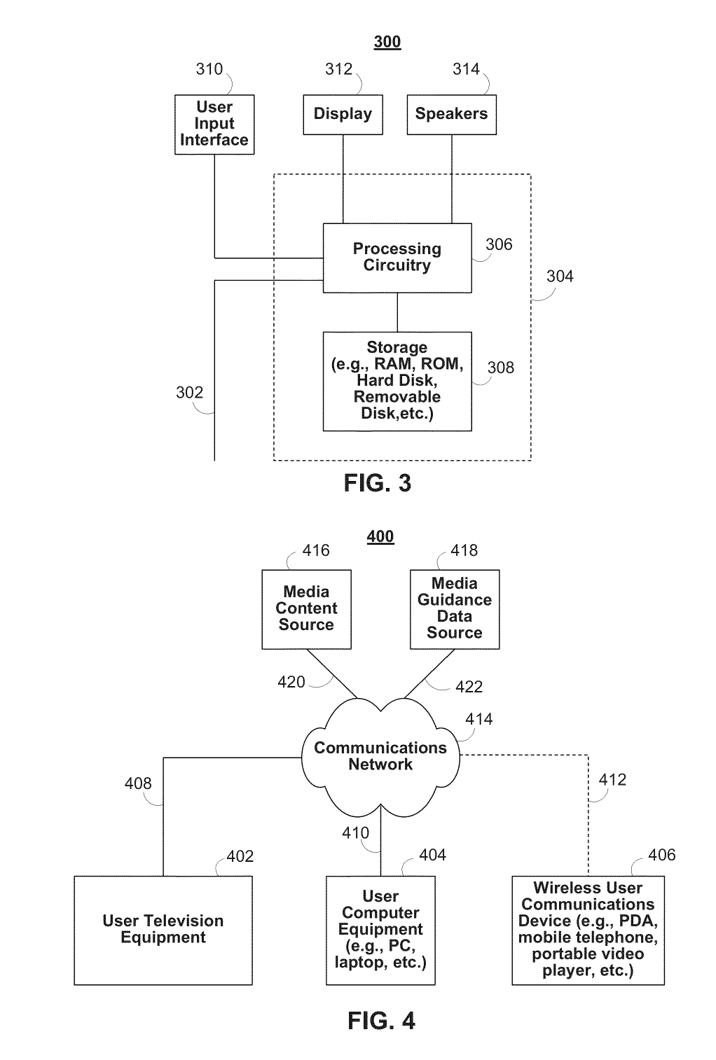

Users may access content and the media guidance application (and its display screens described above and below) from one or more of their user equipment devices. FIG. 3 shows a generalized embodiment of illustrative user equipment device 300. More specific implementations of user equipment devices are discussed below in connection with FIG. 4. User equipment device 300 may receive content and data via input/output (hereinafter “I/O”) path 302. I/O path 302 may provide content (e.g., broadcast programming, on-demand programming, Internet content, content available over a local area network (LAN) or wide area network (WAN), and/or other content) and data to control circuitry 304, which includes processing circuitry 306 and storage 308. Control circuitry 304 may be used to send and receive commands, requests, and other suitable data using I/O path 302. I/O path 302 may connect control circuitry 304 (and specifically processing circuitry 306) to one or more communications paths (described below). I/O functions may be provided by one or more of these communications paths, but are shown as a single path in FIG. 3 to avoid overcomplicating the drawing.

Control circuitry 304 may be based on any suitable processing circuitry such as processing circuitry 306. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, processing circuitry may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 304 executes instructions for a media guidance application stored in memory (i.e., storage 308).

In client-server based embodiments, control circuitry 304 may include communications circuitry suitable for communicating with a guidance application server or other networks or servers. The instructions for carrying out the above mentioned functionality may be stored on the guidance application server. Communications circuitry may include a cable modem, an integrated services digital network (ISDN) modem, a digital subscriber line (DSL) modem, a telephone modem, Ethernet card, or a wireless modem for communications with other equipment, or any other suitable communications circuitry. Such communications may involve the Internet or any other suitable communications networks or paths (which is described in more detail in connection with FIG. 4). In addition, communications circuitry may include circuitry that enables peer-to-peer communication of user equipment devices, or communication of user equipment devices in locations remote from each other (described in more detail below).

Memory may be an electronic storage device provided as storage 308 that is part of control circuitry 304. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid state devices, quantum storage devices, gaming consoles, gaming media, or any other suitable fixed or removable storage devices, and/or any combination of the same. Storage 308 may be used to store various types of content described herein as well as media guidance information, described above, and guidance application data, described above. For example, a plurality of three-dimensional objects representing one or more media assets, animation files that are associated with the three-dimensional objects, and/or any other suitable image for presenting three-dimensional objects may be stored in storage 308. Nonvolatile memory may also be used (e.g., to launch a boot-up routine and other instructions). Cloud-based storage, described in relation to FIG. 4, may be used to supplement storage 308 or instead of storage 308.

Control circuitry 304 may include video generating circuitry and tuning circuitry, such as one or more analog tuners, one or more MPEG-2 decoders or other digital decoding circuitry, high-definition tuners, or any other suitable tuning or video circuits or combinations of such circuits. Encoding circuitry (e.g., for converting over-the-air, analog, or digital signals to MPEG signals for storage) may also be provided. Control circuitry 304 may also include scaler circuitry for upconverting and downconverting content into the preferred output format of the user equipment 300. Circuitry 304 may also include digital-to-analog converter circuitry and analog-to-digital converter circuitry for converting between digital and analog signals. The tuning and encoding circuitry may be used by the user equipment device to receive and to display, to play, or to record content. The tuning and encoding circuitry may also be used to receive guidance data. The circuitry described herein, including for example, the tuning, video generating, encoding, decoding, encrypting, decrypting, scaler, and analog/digital circuitry, may be implemented using software running on one or more general purpose or specialized processors. Multiple tuners may be provided to handle simultaneous tuning functions (e.g., watch and record functions, picture-in-picture (PIP) functions, multiple-tuner recording, etc.). If storage 308 is provided as a separate device from user equipment 300, the tuning and encoding circuitry (including multiple tuners) may be associated with storage 308.

A user may send instructions to control circuitry 304 using user input interface 310. User input interface 310 may be any suitable user interface, such as a remote control, mouse, trackball, keypad, keyboard, touch screen, touchpad, stylus input, joystick, voice recognition interface, or other user input interfaces. In connection with FIGS. 5-6, 7, and 10-11, user input interface 310 may be used to select one of the displayed three-dimensional objects. For example, a user may use arrow keys on a remote control device to scroll across a displayed group of three-dimensional objects until a desired object is highlighted, indicated via a cursor, or identified in some other manner. The user may then press an enter key on the remote control device to transmit the user selection to control circuitry 304. In response to receiving the user selection, control circuitry 304 may cause an animation of the selected three-dimensional object to be presented. In another example, control circuitry 304 may present an animation of a three-dimensional object in response to navigating to the three-dimensional object using user input interface 310.

Display 312 may be provided as a stand-alone device or integrated with other elements of user equipment device 300. Display 312 may be one or more of a monitor, a television, a liquid crystal display (LCD) for a mobile device, or any other suitable equipment for displaying visual images. In some embodiments, display 312 may be HDTV-capable. In some embodiments, display 312 may be a 3D display, and the interactive media guidance application and any suitable content may be displayed in 3D. A video card or graphics card may generate the output to the display 312. The video card may offer various functions such as accelerated rendering of 3D scenes and 2D graphics, MPEG-2/MPEG-4 decoding, TV output, or the ability to connect multiple monitors. The video card may be any processing circuitry described above in relation to control circuitry 304. The video card may be integrated with the control circuitry 304. Speakers 314 may be provided as integrated with other elements of user equipment device 300 or may be stand-alone units. The audio component of videos and other content displayed on display 312 may be played through speakers 314. In some embodiments, the audio may be distributed to a receiver (not shown), which processes and outputs the audio via speakers 314.

In some embodiments, control circuitry 304 may be configured to receive instructions from user input interface 310. For example, control circuitry 304 may cause media guidance application listings to be presented by selecting a selectable option in a display screen (e.g., a listings option) or pressing a dedicated button (e.g., a GUIDE button) on a remote control or other user input interface 310.

In some embodiments, control circuitry 304 may be configured to receive an instruction from user input interface 310 to display three-dimensional objects. In response to receiving the instruction, control circuitry 304 may determine which media assets are represented by three-dimensional objects and retrieve those three-dimensional objects. For example, control circuitry 304 may determine which media assets are currently being presented in a guidance display and, based on the determination, retrieve the corresponding three-dimensional objects from a database, media content source 416, media guidance data source 418, or any other suitable source. In another example, control circuitry 304 may search through metadata associated with the elements provided in a guidance display to determine whether a three-dimensional object is stored in a database, media content source 416, media guidance data source 418, or any other suitable source.

Control circuitry 304 may cause the retrieved three-dimensional objects to be presented in a guidance display. For example, control circuitry 304 may retrieve a plurality of three-dimensional objects that represent channels.

In some embodiments, control circuitry 304 may receive an indication that the user has or navigated to or selected one of the three-dimensional objects. In response to receiving the indication, control circuitry 304 may animate the three-dimensional object. For example, control circuitry 304 may provide one or more animations of the three-dimensional object. In a more particular example, in response to receiving the indication, control circuitry 304 may provide an animation that causes the three-dimensional object to float, spin, and flip over.

While providing the animation of the three-dimensional object, control circuitry 304 may perform an action relating to the media asset represented by the three-dimensional object. For example, when the three-dimensional object represents a channel, control circuitry 304 may tune to the channel, provide a preview of content being currently displayed on the channel, allow the user to schedule a reminder for viewing content on the channel, allow the user to schedule a recording for viewing content on the channel, provide a listing of content associated with the channel, etc.

The guidance application may be implemented using any suitable architecture. For example, it may be a stand-alone application wholly implemented on user equipment device 300. In such an approach, instructions of the application are stored locally, and data for use by the application is downloaded on a periodic basis (e.g., from an out-of-band feed, from an Internet resource, or using another suitable approach). In some embodiments, the media guidance application is a client-server based application. Data for use by a thick or thin client implemented on user equipment device 300 is retrieved on-demand by issuing requests to a server remote to the user equipment device 300. In one example of a client-server based guidance application, control circuitry 304 runs a web browser that interprets web pages provided by a remote server.

In some embodiments, the media guidance application is downloaded and interpreted or otherwise run by an interpreter or virtual machine (run by control circuitry 304). In some embodiments, the guidance application may be encoded in the ETV Binary Interchange Format (EBIF), received by control circuitry 304 as part of a suitable feed, and interpreted by a user agent running on control circuitry 304. For example, the guidance application may be an EBIF application. In some embodiments, the guidance application may be defined by a series of JAVA-based files that are received and run by a local virtual machine or other suitable middleware executed by control circuitry 304. In some of such embodiments (e.g., those employing MPEG-2 or other digital media encoding schemes), the guidance application may be, for example, encoded and transmitted in an MPEG-2 object carousel with the MPEG audio and video packets of a program.

User equipment device 300 of FIG. 3 can be implemented in system 400 of FIG. 4 as user television equipment 402, user computer equipment 404, wireless user communications device 406, or any other type of user equipment suitable for accessing content, such as a non-portable gaming machine. For simplicity, these devices may be referred to herein collectively as user equipment or user equipment devices, and may be substantially similar to user equipment devices described above. User equipment devices, on which a media guidance application may be implemented, may function as a standalone device or may be part of a network of devices. Various network configurations of devices may be implemented and are discussed in more detail below.

A user equipment device utilizing at least some of the system features described above in connection with FIG. 3 may not be classified solely as user television equipment 402, user computer equipment 404, or a wireless user communications device 406. For example, user television equipment 402 may, like some user computer equipment 404, be Internet-enabled allowing for access to Internet content, while user computer equipment 404 may, like some television equipment 402, include a tuner allowing for access to television programming. The media guidance application may have the same layout on various different types of user equipment or may be tailored to the display capabilities of the user equipment. For example, on user computer equipment 404, the guidance application may be provided as a web site accessed by a web browser. In another example, the guidance application may be scaled down for wireless user communications devices 406.

In system 400, there is typically more than one of each type of user equipment device but only one of each is shown in FIG. 4 to avoid overcomplicating the drawing. In addition, each user may utilize more than one type of user equipment device and also more than one of each type of user equipment device.

In some embodiments, a user equipment device (e.g., user television equipment 402, user computer equipment 404, wireless user communications device 406) may be referred to as a “second screen device.” For example, a second screen device may supplement content presented on a first user equipment device. The content presented on the second screen device may be any suitable content that supplements the content presented on the first device. In some embodiments, the second screen device provides an interface for adjusting settings and display preferences of the first device. In some embodiments, the second screen device is configured for interacting with other second screen devices or for interacting with a social network. The second screen device can be located in the same room as the first device, a different room from the first device but in the same house or building, or in a different building from the first device.

The user may also set various settings to maintain consistent media guidance application settings across in-home devices and remote devices. Settings include those described herein, as well as channel and program favorites, programming preferences that the guidance application utilizes to make programming recommendations, display preferences, and other desirable guidance settings. For example, if a user sets a channel as a favorite on, for example, the web site www.allrovi.com on their personal computer at their office, the same channel would appear as a favorite on the user's in-home devices (e.g., user television equipment and user computer equipment) as well as the user's mobile devices, if desired. Therefore, changes made on one user equipment device can change the guidance experience on another user equipment device, regardless of whether they are the same or a different type of user equipment device. In addition, the changes made may be based on settings input by a user, as well as user activity monitored by the guidance application.

The user equipment devices may be coupled to communications network 414. Namely, user television equipment 402, user computer equipment 404, and wireless user communications device 406 are coupled to communications network 414 via communications paths 408, 410, and 412, respectively. Communications network 414 may be one or more networks including the Internet, a mobile phone network, mobile voice or data network (e.g., a 4G or LTE network), cable network, public switched telephone network, or other types of communications network or combinations of communications networks. Paths 408, 410, and 412 may separately or together include one or more communications paths, such as, a satellite path, a fiber-optic path, a cable path, a path that supports Internet communications (e.g., IPTV), free-space connections (e.g., for broadcast or other wireless signals), or any other suitable wired or wireless communications path or combination of such paths. Path 412 is drawn with dotted lines to indicate that in the exemplary embodiment shown in FIG. 4 it is a wireless path and paths 408 and 410 are drawn as solid lines to indicate they are wired paths (although these paths may be wireless paths, if desired). Communications with the user equipment devices may be provided by one or more of these communications paths, but are shown as a single path in FIG. 4 to avoid overcomplicating the drawing.

Although communications paths are not drawn between user equipment devices, these devices may communicate directly with each other via communication paths, such as those described above in connection with paths 408, 410, and 412, as well other short-range point-to-point communication paths, such as USB cables, IEEE 1394 cables, wireless paths (e.g., Bluetooth, infrared, IEEE 802-11x, etc.), or other short-range communication via wired or wireless paths. BLUETOOTH is a certification mark owned by Bluetooth SIG, INC. The user equipment devices may also communicate with each other directly through an indirect path via communications network 414.

System 400 includes content source 416 and media guidance data source 418 coupled to communications network 414 via communication paths 420 and 422, respectively. Paths 420 and 422 may include any of the communication paths described above in connection with paths 408, 410, and 412. Communications with the content source 416 and media guidance data source 418 may be exchanged over one or more communications paths, but are shown as a single path in FIG. 4 to avoid overcomplicating the drawing. In addition, there may be more than one of each of content source 416 and media guidance data source 418, but only one of each is shown in FIG. 4 to avoid overcomplicating the drawing. (The different types of each of these sources are discussed below.) If desired, content source 416 and media guidance data source 418 may be integrated as one source device. Although communications between sources 416 and 418 with user equipment devices 402, 404, and 406 are shown as through communications network 414, in some embodiments, sources 416 and 418 may communicate directly with user equipment devices 402, 404, and 406 via communication paths (not shown) such as those described above in connection with paths 408, 410, and 412.

Content source 416 may include one or more types of content distribution equipment including a television distribution facility, cable system headend, satellite distribution facility, programming sources (e.g., television broadcasters, such as NBC, ABC, HBO, etc.), intermediate distribution facilities and/or servers, Internet providers, on-demand media servers, and other content providers. NBC is a trademark owned by the National Broadcasting Company, Inc., ABC is a trademark owned by the ABC, INC., and HBO is a trademark owned by the Home Box Office, Inc. Content source 416 may be the originator of content (e.g., a television broadcaster, a Webcast provider, etc.) or may not be the originator of content (e.g., an on-demand content provider, an Internet provider of content of broadcast programs for downloading, etc.). Content source 416 may include cable sources, satellite providers, on-demand providers, Internet providers, over-the-top content providers, or other providers of content. Content source 416 may also include a remote media server used to store different types of content (including video content selected by a user), in a location remote from any of the user equipment devices. Systems and methods for remote storage of content, and providing remotely stored content to user equipment are discussed in greater detail in connection with Ellis et al., U.S. Pat. No. 7,761,892, issued Jul. 20, 2010, which is hereby incorporated by reference herein in its entirety.

Media guidance data source 418 may provide media guidance data, such as the media guidance data described above. Media guidance application data may be provided to the user equipment devices using any suitable approach. In some embodiments, the guidance application may be a stand-alone interactive television program guide that receives program guide data via a data feed (e.g., a continuous feed or trickle feed). Program schedule data and other guidance data may be provided to the user equipment on a television channel sideband, using an in-band digital signal, using an out-of-band digital signal, or by any other suitable data transmission technique. Program schedule data and other media guidance data may be provided to user equipment on multiple analog or digital television channels.

In some embodiments, guidance data from media guidance data source 418 may be provided to users' equipment using a client-server approach. For example, a user equipment device may pull media guidance data from a server, or a server may push media guidance data to a user equipment device. In some embodiments, a guidance application client residing on the user's equipment may initiate sessions with source 418 to obtain guidance data when needed, e.g., when the guidance data is out of date or when the user equipment device receives a request from the user to receive data. Media guidance may be provided to the user equipment with any suitable frequency (e.g., continuously, daily, a user-specified period of time, a system-specified period of time, in response to a request from user equipment, etc.). Media guidance data source 418 may provide user equipment devices 402, 404, and 406 the media guidance application itself or software updates for the media guidance application.

Media guidance applications may be, for example, stand-alone applications implemented on user equipment devices. For example, the media guidance application may be implemented as software or a set of executable instructions which may be stored in storage 308, and executed by control circuitry 304 of a user equipment device 300. In some embodiments, media guidance applications may be client-server applications where only a client application resides on the user equipment device, and server application resides on a remote server. For example, media guidance applications may be implemented partially as a client application on control circuitry 304 of user equipment device 300 and partially on a remote server as a server application (e.g., media guidance data source 418) running on control circuitry of the remote server. When executed by control circuitry of the remote server (such as media guidance data source 418), the media guidance application may instruct the control circuitry to generate the guidance application displays and transmit the generated displays to the user equipment devices. The server application may instruct the control circuitry of the media guidance data source 418 to transmit data for storage on the user equipment. The client application may instruct control circuitry of the receiving user equipment to generate the guidance application displays.

Content and/or media guidance data delivered to user equipment devices 402, 404, and 406 may be over-the-top (OTT) content. OTT content delivery allows Internet-enabled user devices, including any user equipment device described above, to receive content that is transferred over the Internet, including any content described above, in addition to content received over cable or satellite connections. OTT content is delivered via an Internet connection provided by an Internet service provider (ISP), but a third party distributes the content. The ISP may not be responsible for the viewing abilities, copyrights, or redistribution of the content, and may only transfer IP packets provided by the OTT content provider. Examples of OTT content providers include YOUTUBE, NETFLIX, and HULU, which provide audio and video via IP packets. Youtube is a trademark owned by Google Inc., Netflix is a trademark owned by Netflix Inc., and Hulu is a trademark owned by Hulu, LLC. OTT content providers may additionally or alternatively provide media guidance data described above. In addition to content and/or media guidance data, providers of OTT content can distribute media guidance applications (e.g., web-based applications or cloud-based applications), or the content can be displayed by media guidance applications stored on the user equipment device.

Media guidance system 400 is intended to illustrate a number of approaches, or network configurations, by which user equipment devices and sources of content and guidance data may communicate with each other for the purpose of accessing content and providing media guidance. The embodiments described herein may be applied in any one or a subset of these approaches, or in a system employing other approaches for delivering content and providing media guidance. The following four approaches provide specific illustrations of the generalized example of FIG. 4.

In one approach, user equipment devices may communicate with each other within a home network. User equipment devices can communicate with each other directly via short-range point-to-point communication schemes describe above, via indirect paths through a hub or other similar device provided on a home network, or via communications network 414. Each of the multiple individuals in a single home may operate different user equipment devices on the home network. As a result, it may be desirable for various media guidance information or settings to be communicated between the different user equipment devices. For example, it may be desirable for users to maintain consistent media guidance application settings on different user equipment devices within a home network, as described in greater detail in Ellis et al., U.S. patent application Ser. No. 11/179,410, filed Jul. 11, 2005. Different types of user equipment devices in a home network may also communicate with each other to transmit content. For example, a user may transmit content from user computer equipment to a portable video player or portable music player.

In a second approach, users may have multiple types of user equipment by which they access content and obtain media guidance. For example, some users may have home networks that are accessed by in-home and mobile devices. Users may control in-home devices via a media guidance application implemented on a remote device. For example, users may access an online media guidance application on a website via a personal computer at their office, or a mobile device such as a PDA or web-enabled mobile telephone. The user may set various settings (e.g., recordings, reminders, or other settings) on the online guidance application to control the user's in-home equipment. The online guide may control the user's equipment directly, or by communicating with a media guidance application on the user's in-home equipment. Various systems and methods for user equipment devices communicating, where the user equipment devices are in locations remote from each other, is discussed in, for example, Ellis et al., U.S. Pat. No. 8,046,801, issued Oct. 25, 2011, which is hereby incorporated by reference herein in its entirety.

In a third approach, users of user equipment devices inside and outside a home can use their media guidance application to communicate directly with content source 416 to access content. Specifically, within a home, users of user television equipment 402 and user computer equipment 404 may access the media guidance application to navigate among and locate desirable content. Users may also access the media guidance application outside of the home using wireless user communications devices 406 to navigate among and locate desirable content.

In a fourth approach, user equipment devices may operate in a cloud computing environment to access cloud services. In a cloud computing environment, various types of computing services for content sharing, storage or distribution (e.g., video sharing sites or social networking sites) are provided by a collection of network-accessible computing and storage resources, referred to as “the cloud.” For example, the cloud can include a collection of server computing devices, which may be located centrally or at distributed locations, that provide cloud-based services to various types of users and devices connected via a network such as the Internet via communications network 414. These cloud resources may include one or more content sources 416 and one or more media guidance data sources 418. In addition or in the alternative, the remote computing sites may include other user equipment devices, such as user television equipment 402, user computer equipment 404, and wireless user communications device 406. For example, the other user equipment devices may provide access to a stored copy of a video or a streamed video. In such embodiments, user equipment devices may operate in a peer-to-peer manner without communicating with a central server.

The cloud provides access to services, such as content storage, content sharing, or social networking services, among other examples, as well as access to any content described above, for user equipment devices. Services can be provided in the cloud through cloud computing service providers, or through other providers of online services. For example, the cloud-based services can include a content storage service, a content sharing site, a social networking site, or other services via which user-sourced content is distributed for viewing by others on connected devices. These cloud-based services may allow a user equipment device to store content to the cloud and to receive content from the cloud rather than storing content locally and accessing locally-stored content.

A user may use various content capture devices, such as camcorders, digital cameras with video mode, audio recorders, mobile phones, and handheld computing devices, to record content. The user can upload content to a content storage service on the cloud either directly, for example, from user computer equipment 404 or wireless user communications device 406 having content capture feature. Alternatively, the user can first transfer the content to a user equipment device, such as user computer equipment 404. The user equipment device storing the content uploads the content to the cloud using a data transmission service on communications network 414. In some embodiments, the user equipment device itself is a cloud resource, and other user equipment devices can access the content directly from the user equipment device on which the user stored the content.

Cloud resources may be accessed by a user equipment device using, for example, a web browser, a media guidance application, a desktop application, a mobile application, and/or any combination of access applications or the same. The user equipment device may be a cloud client that relies on cloud computing for application delivery, or the user equipment device may have some functionality without access to cloud resources. For example, some applications running on the user equipment device may be cloud applications, i.e., applications delivered as a service over the Internet, while other applications may be stored and run on the user equipment device. In some embodiments, a user device may receive content from multiple cloud resources simultaneously. For example, a user device can stream audio from one cloud resource while downloading content from a second cloud resource. Or, a user device can download content from multiple cloud resources for more efficient downloading. In some embodiments, user equipment devices can use cloud resources for processing operations such as the processing operations performed by processing circuitry described in relation to FIG. 3.

In some embodiments, control circuitry 304 may display one or more program listings simultaneously with a program or video of the program being watched. In particular, control circuitry 304 may allow the user to browse through program listings for other programs while watching the program on the display. Control circuitry 304 may display the program listing or multiple program listings by providing a display similar to display 200 of FIG. 2. While browsing through program listings, control circuitry 304 may provide the user with three-dimensional objects in the guidance display. For example, as shown in FIG. 2, control circuitry 304 may provide the user with three-dimensional mode option 220.

In response to receiving an indication that the user has selected three-dimensional mode option 220, control circuitry 304 may determine whether the processing capabilities of the user equipment (e.g., the video card connected to control circuitry 304) are suitable for presenting guidance displays with three-dimensional objects. In another example, based on the capabilities of the user equipment, control circuitry 304 may provide a reduced number of three-dimensional objects in the guidance displays. Alternatively, control circuitry 304 may perform these capability determinations prior to activating three-dimensional mode option 220.

In some embodiments, in response to receiving an indication that the user has selected three-dimensional mode option 220, control circuitry 304 may query a database, media content source 416, media guidance data source 418, or any other suitable source for three-dimensional objects, animations associated with each of the three-dimensional objects, and any other suitable data available for presentation. In response to receiving the three-dimensional objects and other data, control circuitry 304 may store the three-dimensional objects in storage 308 and/or determine which of the three-dimensional objects to present to the user in guidance display 500. This selection may be based, for example, on availability, user history, user preferences, etc.

Alternatively or additionally, control circuitry 304 may review the metadata associated with the elements provided in the guidance display to determine whether a three-dimensional object is stored in a database, media content source 416, media guidance data source 418, or any other suitable source. In response to the determination, control circuitry 304 may transmit a query to the database for the available three-dimensional object.

Control circuitry 304 may then provide the user with a guidance display that contains three-dimensional objects, where the three-dimensional objects represent media assets. An illustrative guidance display that includes three-dimensional objects for providing media guidance is shown in FIG. 5. Display 500 includes a group of selectable three-dimensional objects 502 representing various channels, which are each presented in the shape of a cube. Each of the three-dimensional objects has a surface 504 that may include text, a still image, a logo, cover art, or any other indication thereon that identifies or provides information about the media asset represented by the three-dimensional object. For example, where the media asset is a television channel, surface 504 may include a channel call sign, a channel number, or any other suitable identifier.

It should be noted that, although the group of three-dimensional objects 502 are presented as cubes, the three-dimensional objects may be presented as any other suitable shape, such as, for example, a rectangular prism, a triangular prism, a sphere, a cylinder, a cone, or a pyramid. It should also be noted that, although the three-dimensional objects in group of three-dimensional objects 502 are shown to have the same shape, some or all of the three-dimensional objects in group 502 may have different shapes.

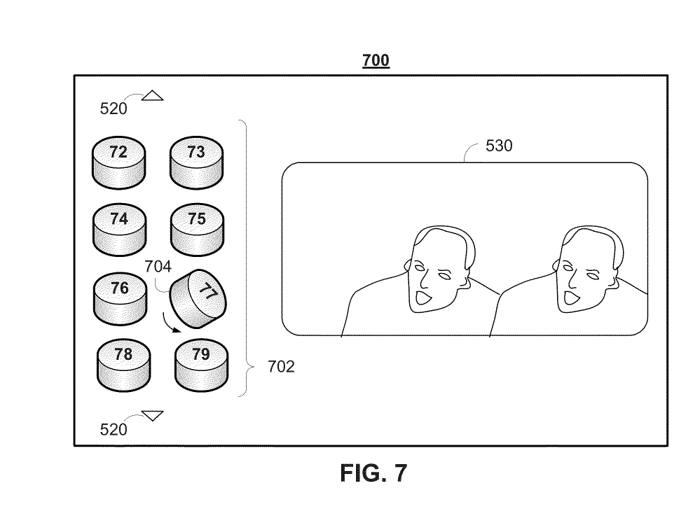

As shown in display 500, group of selectable three-dimensional objects 502 are presented as being horizontally aligned across a bottom portion of display 500. It should be noted that group of three-dimensional objects 502 is not limited to being arranged in horizontal alignment across a bottom portion of display 500, but instead, may be arranged, for example, in horizontal alignment across a top portion of display 500. For example, group of selectable three-dimensional objects 502 may be arranged, for example, vertically, diagonally, in two or more rows or columns, or in separate groups (e.g., four groups of four three-dimensional objects arranged in 2×2 blocks). In a more particular example, FIG. 7 illustrates that a group of selectable three-dimensional objects 702 may be arranged in two columns. In addition, the three-dimensional objects may be displayed across or in any suitable portion of the display, which may, in some implementations, depend on the arrangement of other display regions and/or features.

Each three-dimensional object may represent a media asset. The media asset may be, for example, a television channel, a content source, a program of a certain type (e.g., favorite, sports, news, children, etc.), a program category, a song from a particular album, a radio station, a third-party application (e.g., a YouTube application), locally stored content, on-demand content, or Internet content. For example, as shown in FIGS. 5-12, the three-dimensional objects represent or identify particular channels.

In addition, each three-dimensional object from group of three-dimensional objects 502 may be a subset of a plurality of three-dimensional objects. For example, control circuitry 304 may retrieve a plurality of three-dimensional objects, each of which represents one of hundreds of channels. In response, control circuitry 304 may select for presentation a subset of those channels (e.g., ten three-dimensional objects). This may be based on the media asset represented by the three-dimensional object, the size of the display, the type of user equipment executing the media guidance application, and/or user preferences (e.g., display five objects at any given time).

In some embodiments, control circuitry 304 may allow the user to navigate or scroll through the group of three-dimensional objects 502 (e.g., using a remote control or any other suitable user input device). In response to the user navigating to a three-dimensional object, such as a three-dimensional object 514, three-dimensional object 514 may be highlighted using, for example, a cursor, a color change, a brightness or hue change, etc. A user may then select a highlighted three-dimensional object by pressing a suitable key on the user input device (e.g., an enter key). In response to receiving the user selection of three-dimensional object 514 from group of three-dimensional objects 502, control circuitry 304 may animate three-dimensional object 514. Alternatively, control circuitry 304 may animate three-dimensional object 514 in response to detecting that the user has navigated to three-dimensional object 514.

FIG. 6 show an illustrative example of a three-dimensional object that has been animated within guidance display 600. For example, control circuitry 304 may retrieve one or more animations that are associated with three-dimensional object 514 of FIG. 5. In response to providing the one or more animations, control circuitry 304 may cause the three-dimensional object to perform a floating motion, a bouncing motion, a vibrating motion, a rotating motion, a sliding motion, a flipping motion, any other suitable motion, and/or any combination thereof. For example, as shown in FIG. 6, three-dimensional object 614 shows the three-dimensional object that represents the channel “FOX” floating and spinning relative to the other three-dimensional objects 511, 512, 513, and 515.

Additionally or alternatively, control circuitry 304 may modify properties associated with selected three-dimensional object 614. In particular, control circuitry 304 may modify the height, width, aspect ratio, rotation, scale, color, shading, shape, position, and/or alignment of the selected three-dimensional object. For example, as described in connection with FIG. 10, control circuitry 304 has modified the height, aspect ratio, and shading of the selected three-dimensional object 1003.

In some embodiments, the animation of three-dimensional object 614 may provide additional features to the replaced channel identifier. For example, the animation may include an audio clip that instructs control circuitry 304 to play back the audio clip through speakers 314 in response to receiving an indication that the user has navigated to or selected three-dimensional object 614.

It should be noted that, in some embodiments, control circuitry 304 may present one or more animations of a three-dimensional object relative to the three-dimensional objects not selected by the user. For example, control circuitry 304 may provide the selected three-dimensional object in a plane different from the plane in which the non-selected objects are located. In another example, control circuitry 304 may maintain the alignment of non-selected three-dimensional objects, while the animation of the selected three-dimensional object may occur out of that alignment. In yet another example, control circuitry 304 may animate the selected three-dimensional object while the non-selected three-dimensional objects remain still.

As shown in FIG. 6, the three-dimensional objects that were not selected by the user (e.g., objects 511, 512, 513, and 515) remain still and in horizontal alignment with each other. For example, control circuitry 304 may animate selected three-dimensional object 614 as the selected object remains in alignment with the non-selected three-dimensional objects. As shown in FIG. 7, control circuitry 304 presents an animation of selected object 703 that tilts and spins selected object 704, while remaining in vertical alignment with non-selected objects 702 in the same column and in horizontal alignment with the non-selected objects 702 in the same row. Alternatively, control circuitry 304 may animate non-selected objects 702, where the animation hides, minimizes, or de-emphasizes them from selected three-dimensional object 704 (e.g., an animation that causes the unselected objects to fade back).

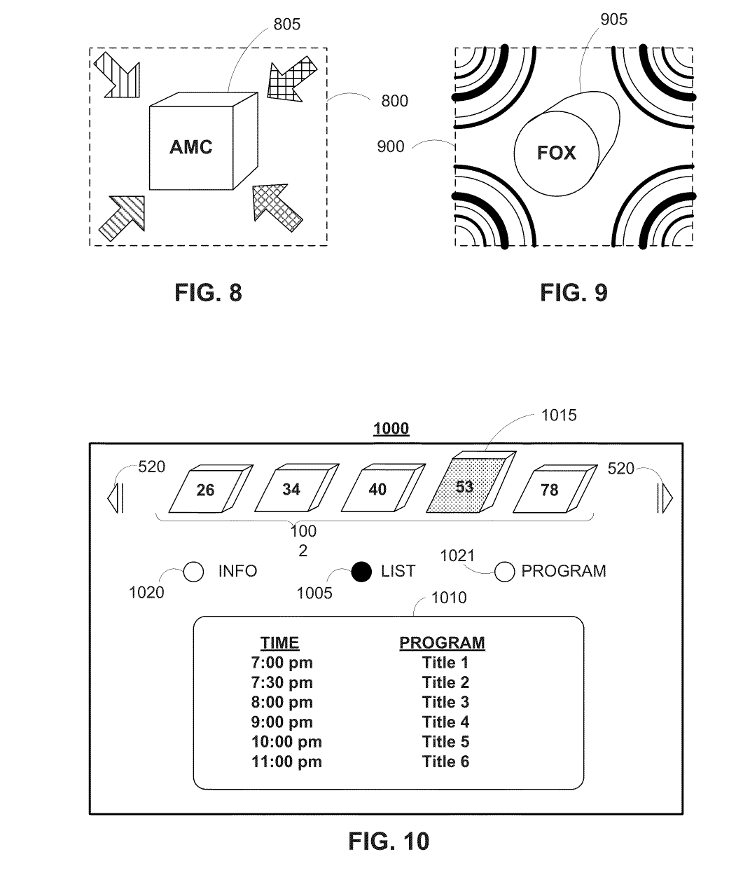

It should be noted that, in some embodiments, control circuitry 304 may animate a region of the guidance display that contains a selected three-dimensional object. For example, as shown in FIG. 8, control circuitry 304 may animate a region 800 that includes a selected three-dimensional object 805, where additional animated images or objects are presented (e.g., moving arrows striking selected object 805). In another example, as shown in FIG. 9, control circuitry 304 may animate a region 900 that includes a three-dimensional objection 905, where surrounding pattern, background color, or shading variations are presented.

The media assets represented by group of three-dimensional objects may be, for example, a sequential numerical listing of channels, a retrieved list of favorite channels, or an alphabetical listing of channels. As shown in FIGS. 5 and 6, control circuitry 304 may provide the user with navigational options. For example, the user may select one of navigational icons 520 (e.g., by pressing an appropriate arrow key on a user input device) to cause control circuitry 304 to provide different three-dimensional objects representing different television channels. Each selection of navigational icon 520 may cause one or more different three-dimensional objects, representing one or more different channels, to be added to group of displayed three-dimensional objects 502. In FIGS. 5 and 6, the added three-dimensional objects, which may represent the next channels in numerical or alphabetical order, may be displayed either on the left or right side of group of three-dimensional objects 502. The added three-dimensional objects may scroll or slide into the display, while a like number of three-dimensional objects on the opposite side of group of three-dimensional objects 502 may concurrently scroll or slide out of the display in order to maintain the same number of displayed three-dimensional objects.

Alternatively, in some embodiments, selecting navigational icon 520 may cause control circuitry 304 to replace group of three-dimensional objects 502 with a new subset of three-dimensional objects that may represent a different subset of channels. The different subset of channels may be, for example, the next group of sequentially numbered or alphabetically ordered channels.

In some embodiments, control circuitry 304 may receive an indication that the user has selected a subsequent three-dimensional object, such as object 513. In response to receiving the indication, control circuitry 304 may cease to animate three-dimensional object 614, cause three-dimensional object to returns to its original position in alignment with the other non-selected three-dimensional objects, and animate the subsequently selected three-dimensional object. It should be noted that the animation of a subsequently selected object may be the same as, or different than, the animation of the previously selected object. For example, the animation associated with a first selected three-dimensional object may include a rotating motion, while the animation associated with a second selected three-dimensional object may include a floating motion with a shape change and a region animation.

Upon providing one or more animations of the three-dimensional object to the user, control circuitry 304 may display content associated with the media asset represent by the selected three-dimensional object. For example, referring back to FIG. 6, in response to displaying the animation that causes three-dimensional object 614 for the channel “FOX” to float and rotate, control circuitry 304 may tune to the corresponding channel and provide the user with the associated content in display area 530. In another example, control circuitry 304 may provide a preview of content being displayed on the corresponding channel.

Additionally or alternatively to accessing the content corresponding to the selected three-dimensional object (e.g., by tuning to the channel), control circuitry 304 may perform any suitable action relating to the media asset represented by the selected three-dimensional object. For example, when the three-dimensional object represents a channel, control circuitry 304 may allow the user to schedule a reminder for viewing content on the channel, allow the user to schedule a recording for viewing content on the channel, provide a listing of content associated with the channel, etc. In another example, control circuitry 304 may instruct a second screen device (e.g., wireless user communications device 406) to tune to the associated content, record the content, set a reminder to watch the content, etc. In some embodiments, control circuitry 304 may select the three-dimensional object on a first user equipment device and instruct control circuitry 304 to instruct the second screen device to tune to the content and simultaneously record the content in a storage device connected to the first user equipment device. In some embodiments, control circuitry 304 may provide an animation of a selected three-dimensional object that continues from the first user equipment device to the second screen device.

In some embodiments, control circuitry 304 may allow the user to select from various options to customize guidance displays and the presentation of three-dimensional objects. For example, instead of accessing the content corresponding to the selected three-dimensional object (e.g., by tuning to the channel), control circuitry 304 may prompt the user to select content or information for presentation in the guidance display. For example, FIG. 10 provides the user with an illustrative customization display 1000. As shown, in response to receiving an indication that the user has selected list option 1005 in display 1000, display area 1010 may present the user with a list of programs organized by start time for the channel represented by selected three-dimensional object 1015. In another example, in response to receiving an indication that the user has selected information option 1020, control circuitry may display program information in display area 1010 (e.g., similar to that displayed in program information region 112 of FIG. 1).

It should be noted that any suitable portion of the guidance displays described herein may be rendered by control circuitry 304 as a three-dimensional object. For example, program listings may be displayed as three-dimensional objects. In another example, the selectable options within an options region may be displayed as three-dimensional objects, where each three-dimensional object represents a selectable option and user selection of one of the three-dimensional objects causes that object to appear animated relative to the non-selected three-dimensional objects. In yet another example, one or more of navigational icons may be displayed as three-dimensional objects.

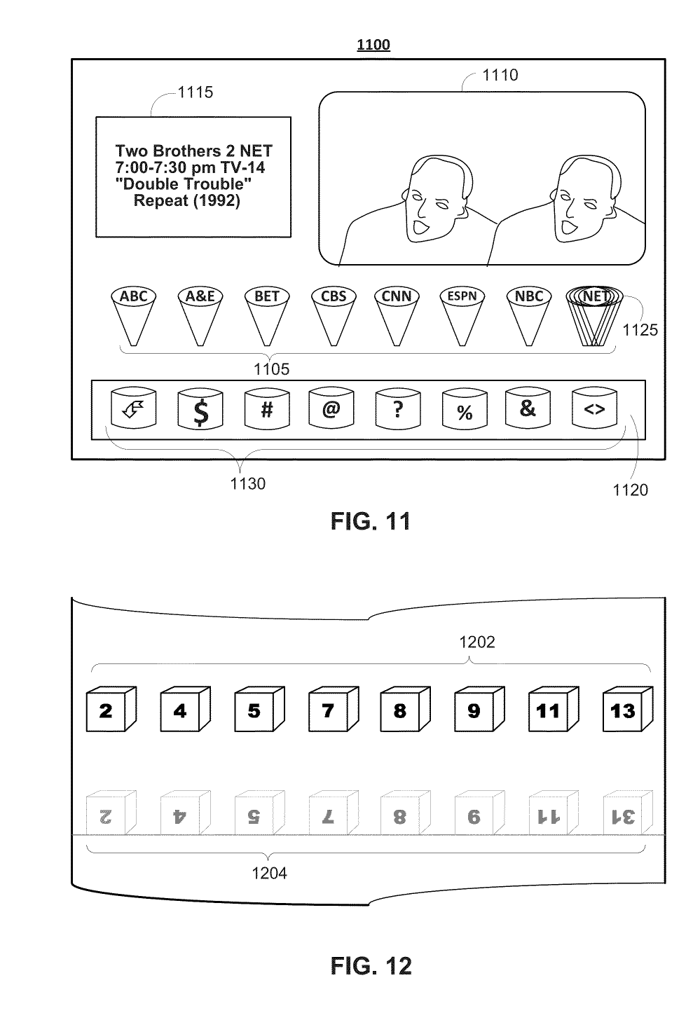

In a more particular example, FIG. 11 shows an illustrative guidance display 1100 that includes three-dimensional objects 1105 for representing various channels or content sources, a display area 1110, information region 1115, and an options region 1120 that includes three-dimensional objects 1130 for various options. Information region 1115 may provide information corresponding to content being shown in display area 1120 in response to the selection of a three-dimensional object 1125, which is shown with a vibrating motion animation. Options region 1120 may also include selectable options that are represented by three-dimensional objects 1130. In response to receiving a user selection of one of objects 1130, control circuitry 304 may animate the selected three-dimensional object relative to the non-selected three-dimensional objects and/or provide the user with the associated option.

In some embodiments, other visually or aesthetically pleasing effects or features may be added to the presentation of three-dimensional objects. For example, as shown in FIG. 12, to create an appearance of the displayed group of three-dimensional objects floating in air, control circuitry 304 may render a group of three-dimensional objects 1202 with reflected versions of the three-dimensional objects 1204.

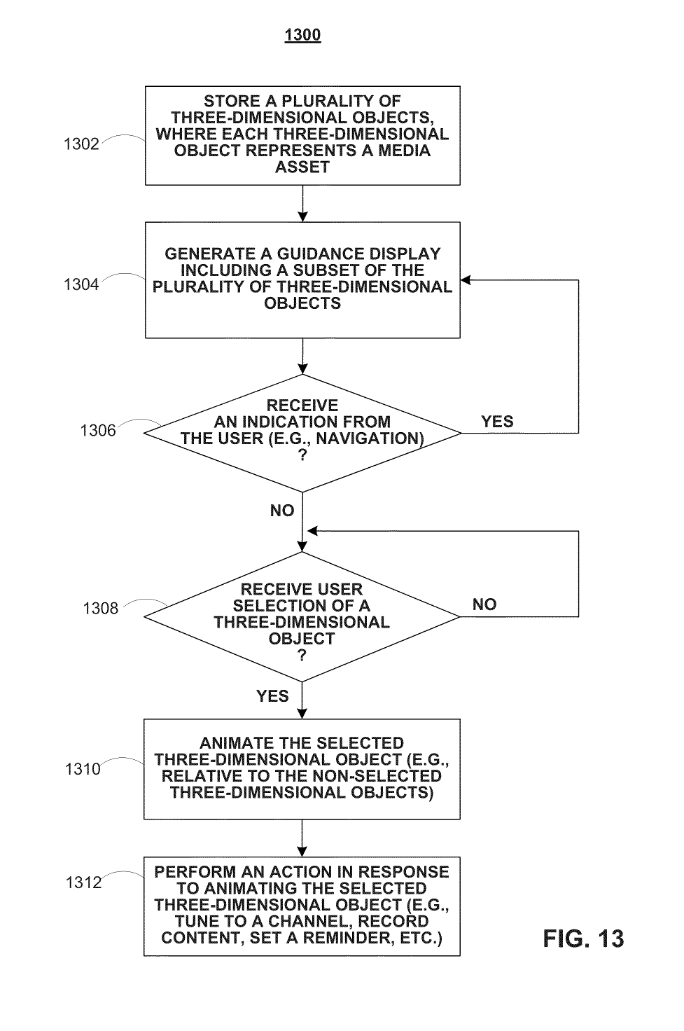

FIG. 13 is an illustrative flow diagram 1300 for presenting animated three-dimensional objects representing a type of media asset in a media guidance application in accordance with an embodiment of the invention.

At step 1302, control circuitry 304 may store a plurality of three-dimensional objects, where each of the three-dimensional objects represents a media asset. The media asset may be, for example, a channel (e.g., FOX), a content type identifier (e.g., CNN.com), an identifier for a third-party application (e.g., a YouTube application), a listing for a television program, or any other suitable media asset. For example, in response to receiving an indication to present three-dimensional objects (e.g., three-dimensional mode option 220 in FIG. 2), control circuitry 304 may retrieve one or more three-dimensional objects associated with media assets from a database and store the three-dimensional objects. In another example, in response to receiving the indication, control circuitry 304 may determine the type of guidance display that is being presented to the user and search through the metadata associated with the elements provided on the guidance display to determine whether three-dimensional objects are available in one or more databases.

Any suitable mechanism for retrieving three-dimensional objects to be presented in a guidance display may be used. For example, in some embodiments, control circuitry 304 may transmit a query to storage for three-dimensional objects (e.g., for a particular content source, for a particular content type, a particular identifier, having a particular motion, of a particular size, etc.). In response to receiving the three-dimensional objects and information associated with the three-dimensional objects from storage (e.g., in an XML structure as illustrated in FIG. 13), control circuitry 304 may store the three-dimensional objects and their associated information (e.g., animation files, image files, etc.).

At step 1304, control circuitry 304 may generate a guidance display that includes a subset of the plurality of three-dimensional objects. For example, a user may navigate through a browse display, such as grid 102 of FIG. 1, and select a three-dimensional mode option, such as option 220 of FIG. 2. In response, control circuitry 304 may determine a subset of the plurality of three-dimensional objects to display on the guidance display. The selection may be based on the media asset, properties associated with the guidance display being presented, properties or capabilities of the user equipment displaying the three-dimensional objects, etc. For example, if the media assets are channels or content sources, the first subset of three-dimensional objects may be a first group of alphabetically-listed channels.

It should be noted that, in response to determining that a particular subset of three-dimensional objects is to be displayed, control circuitry 304 may retrieve the corresponding three-dimensional objects and information associated with the three-dimensional objects (e.g., animation files, image files, audio files, etc.) from storage (e.g., in an XML structure as illustrated in FIG. 13).

At step 1306, control circuitry 304 may monitor the navigation through the guidance display performed by the user. For example, in response to determining that the user has selected navigational icons (e.g., navigational icon 520 of FIG. 5) on the guidance display, control circuitry 304 may return to step 1304 and generate a guidance display that includes a second subset of the three-dimensional objects. In another example, in response to determining that the user has navigated to a different guidance display, control circuitry 304 may determine whether elements on the guidance display may be replaced with three-dimensional objects and generate the guidance display.

At step 1308, control circuitry 304 may receive a user selection of one of the displayed three-dimensional objects has been received. For example, control circuitry 304 may determine that the user has selected a three-dimensional object using user input interface 310. In another example, control circuitry 304 may determine that the user has navigated or highlighted a particular three-dimensional object on the guidance display.

At step 1310, in response to receiving a user selection of a three-dimensional object, control circuitry 304 may animate the selected three-dimensional object is animated. As described above, the animation may cause the three-dimensional object to perform particular motions, such as a floating motion, a flipping motion, a bouncing motion, a vibrating motion, a rotating motion, a sliding motion, and/or any combination thereof. In a more particular example, the three-dimensional object may be animated such that a floating motion is provided for a first time period, color changes are provided for a second time period, and a rotating motion is provided for a third time period, where the sequence of animations may repeat after the third time period elapses. The three-dimensional object may be animated based on, for example, a user preference or a predefined setting associated with the media asset represented by the three-dimensional object, etc.

At step 1312, upon animating the selected three-dimensional object, control circuitry 304 may perform an action associated with the media asset represented by the three-dimensional object. For example, when the three-dimensional object represents a channel, the media guidance application may tune to the channel, provide a preview of content being currently displayed on the channel, allow the user to schedule a reminder for viewing content on the channel, allow the user to schedule a recording for viewing content on the channel, provide a listing of content associated with the channel, etc. It should be noted that control circuitry 304 may perform the action or prompt the user to perform the action concurrently with the generating and/or presenting the one or more animations of the selected three-dimensional object.

It should be understood that the above steps of the flow diagram of FIG. 13 may be executed or performed in any order or sequence not limited to the order and sequence shown and described in the figure. Also, some of the above steps of the flow diagram of FIG. 13 may be executed or performed substantially simultaneously where appropriate or in parallel to reduce latency and processing times.

The above described embodiments of the present disclosure are presented for purposes of illustration and not of limitation, and the present disclosure is limited only by the claims which follow.

1. A method for presenting an interactive media guidance application, the method comprising:
storing a plurality of three-dimensional objects, wherein each of the plurality of three-dimensional objects represents a media asset;
causing a subset of the plurality of three-dimensional objects to be presented to a user;
receiving a user selection of a three-dimensional object from the subset of the plurality of three-dimensional objects; and
in response to receiving the user selection, animating the three-dimensional object relative to the subset of the plurality of three-dimensional objects not selected by the user.

2. The method of claim 1, wherein each of the plurality of three-dimensional objects is presented in a shape of at least one of: a cube, a sphere, a rectangular prism, a triangular prism, a cylinder, a cone, and a pyramid.

3. The method of claim 1, wherein the animating further comprises causing the three-dimensional object to perform at least one of: a floating motion, a bouncing motion, a vibrating motion, a rotating motion, a sliding motion, and a flipping motion.

4. The method of claim 1, wherein the subset of the plurality of three-dimensional objects not selected by the user remain still upon animating the three-dimensional object in response to the user selection.

5. The method of claim 1, wherein the animating further comprises causing properties associated with the three-dimensional object to be modified, the properties comprising one or more of: height, width, aspect ratio, rotation, scale, color, shading, shape, position, and alignment.

6. The method of claim 1, wherein the subset of the plurality of three-dimensional objects presented to the user are aligned horizontally, the method further comprising causing the three-dimensional object to have a different horizontal alignment from the subset of the plurality of three-dimensional objects not selected by the user in response to receiving the user selection.

7. The method of claim 1, wherein the animating further comprises animating a region containing the three-dimensional object in response to receiving the user selection.

8. The method of claim 1, wherein the media asset is a channel.

9. The method of claim 1, further comprising causing a program associated with the media asset represented by the three-dimensional object to be presented to the user in response to receiving the user selection.

10. The method of claim 9, further comprising causing the program associated with the media asset to be simultaneously displayed with the subset of the plurality of three-dimensional objects in response to receiving the user selection.

11. A system for presenting an interactive media guidance application to a user, the system comprising:
a storage device; and
processing circuitry configured to:
store a plurality of three-dimensional objects in the storage device, wherein each of the plurality of three-dimensional objects represents a media asset;
cause a subset of the plurality of three-dimensional objects from the storage device to be presented to a user;
receive a user selection of a three-dimensional object from the subset of the plurality of three-dimensional objects; and
in response to receiving the user selection, animate the three-dimensional object relative to the subset of the plurality of three-dimensional objects not selected by the user.

12. The system of claim 11, wherein each of the plurality of three-dimensional objects is presented in a shape of at least one of: a cube, a sphere, a rectangular prism, a triangular prism, a cylinder, a cone, and a pyramid.

13. The system of claim 11, wherein the processing circuitry is further configured to animate the three-dimensional object to perform at least one of: a floating motion, a bouncing motion, a vibrating motion, a rotating motion, a sliding motion, and a flipping motion.

14. The system of claim 11, wherein the subset of the plurality of three-dimensional objects not selected by the user remain still upon animating the three-dimensional object in response to the user selection.

15. The system of claim 11, wherein the processing circuitry is further configured to animate the three-dimensional object by causing properties associated with the three-dimensional object to be modified, the properties comprising one or more of height, width, aspect ratio, rotation, scale, color, shading, shape, position, and alignment.

16. The system of claim 11, wherein the subset of the plurality of three-dimensional objects presented to the user are aligned horizontally and wherein the processing circuitry further configured to cause the three-dimensional object to have a different horizontal alignment from the subset of the plurality of three-dimensional objects not selected by the user in response to receiving the user selection.

17. The system of claim 11, wherein the processing circuitry is further configured to animate a region containing the three-dimensional object in response to receiving the user selection.

18. The system of claim 11, wherein the media asset is a channel.

19. The system of claim 11, wherein the processing circuitry is further configured to cause a program associated with the media asset represented by the three-dimensional object to be presented to the user in response to receiving the user selection.

20. The system of claim 19, wherein the processing circuitry is further configured to cause the program associated with the media asset to be simultaneously displayed with the subset of the plurality of three-dimensional objects in response to receiving the user selection.

21-30. (canceled)
